(19) United States
(12) Patent Application Publication
(10) Pub. No.: US 2026/0138461 A1
(43) Pub. Date: May 21, 2026

(54) Dynamic Regenerative Braking for Stopping in One-Pedal Driving

(71) Applicant: Nissan North America, Inc., Franklin, TN (US)

(72) Inventors: Sachin Hagaribommanahalli Yeriyappa, San Jose, CA (US); Christopher Ostafew, Mountain View, CA (US)

(21) Appl. No.: 18/955,231

(22) Filed: Nov. 21, 2024

(51) Int. Cl. B60L 7/18; B60L 15/20

(52) U.S. Cl. CPC B60L 7/18; B60L 15/2009; B60L 2240/12; B60L 2250/16; B60L 2250/26

(57) ABSTRACT

Auto-deceleration of an electric vehicle (EV) is described. A stop line ahead of the EV is detected using map data or sensor inputs. A deceleration plan is generated for the EV. The deceleration plan is based on at least a distance to the stop line, a current speed of the EV. The deceleration plan ends at the stop line. A full release of an accelerator pedal by a driver is detected. Using regenerative braking or coast torque adjustments, acceleration or deceleration of the EV is adjusted based on the deceleration plan.

### TECHNICAL FIELD

This disclosure relates generally to electric vehicles, and more particularly to dynamic regenerative braking for stopping in one-pedal driving.

### BACKGROUND

A vehicle may traverse across sections of a transportation network, such as a road, primarily through a driver's control of an accelerator pedal. This engagement with the accelerator pedal generates torque, which is subsequently converted into vehicle's speed. The manner and skill with which the accelerator pedal is operated can significantly influence a vehicle's operation and an efficiency, and an overall driving experience of a driver.

### SUMMARY

A first aspect of the disclosed implementations is a method implemented by an electric vehicle (EV) using one-pedal driving. The method includes detecting a stop line ahead of the EV using map data or sensor inputs; generating a deceleration plan for the EV, wherein the deceleration plan is based on at least a distance to the stop line, a current speed of the EV, and wherein the deceleration plan ends at the stop line; detecting a full release of an accelerator pedal by a driver; and adjusting, using regenerative braking or coast torque adjustments, acceleration or deceleration of the EV based on the deceleration plan.

A second aspect of the disclosed implementations is an electric vehicle that includes a processor. The processor is configured to detect a stop line ahead of the EV using map data or sensor inputs; generate a deceleration plan for the EV, wherein the deceleration plan is based on at least a distance to the stop line, a current speed of the EV, and wherein the deceleration plan ends at the stop line; detect a full release of an accelerator pedal by a driver; and adjust, using regenerative braking or coast torque adjustments, acceleration or deceleration of the EV based on the deceleration plan.

A third aspect of the disclosed implementations is a non-transitory computer readable medium storing instructions operable to cause one or more processors to perform operations with respect to an electric vehicle (EV) using one-pedal driving. The operations include detecting a stop line ahead of the EV using map data or sensor inputs; generating a deceleration plan for the EV, wherein the deceleration plan is based on at least a distance to the stop line, a current speed of the EV, and wherein the deceleration plan ends at the stop line; detecting a full release of an accelerator pedal by a driver; and adjusting, using regenerative braking or coast torque adjustments, acceleration or deceleration of the EV based on the deceleration plan.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects of the methods and apparatuses disclosed herein will become more apparent by referring to the examples provided in the following description and drawings in which like reference numbers refer to like elements.

FIG. 1 is a diagram of an example of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 briefly illustrates the default operations of Active Deceleration Mode (ADM) and Smooth Coast Mode (SCM) in the context of one-pedal driving, with a focus on the behavior when the accelerator pedal is fully released.

FIG. 4 illustrates a scenario for dynamic regenerative braking in one-pedal driving, demonstrating how the braking behavior of a vehicle is dynamically adjusted to stop at a desired stop line.

FIG. 5 illustrates a block diagram of a system for dynamic regenerative braking for stopping in one-pedal driving.

FIG. 6A includes a flowchart of a technique 600 for generating a speed plan.

FIG. 6B is an example of determining a speed plan.

FIG. 6C illustrates generating a deceleration plan from the smooth speed plan of FIG. 6B.

FIG. 6D illustrates an example of generating a deceleration plan where map data is not available.

FIG. 6E illustrates an accelerator pedal output (APO) comparison between manual driving and auto-deceleration at an intersection.

FIG. 7 is a flowchart of an examples of a technique that can be used for dynamic regenerative braking for stopping in one-pedal driving.

FIG. 8A is a flowchart of a technique for calculating a distance of a vehicle to a stop line.

FIG. 8B is used to illustrate steps in the flowchart of FIG. 8A.

FIG. 9 is a flowchart of a technique for implementing one-pedal driving in an EV by dynamically managing deceleration to achieve smooth stops at stop lines.

### DETAILED DESCRIPTION

In electric vehicles (EVs), one-pedal driving is a control scheme that allows the driver to accelerate and decelerate using only the accelerator pedal. In such systems, pressing the accelerator pedal increases the speed of the vehicle, while releasing the pedal initiates deceleration. One-pedal driving enhances the driving experience by streamlining vehicle control and reducing the frequency with which drivers need to use a brake pedal, if available. One-pedal driving is closely tied to regenerative braking, which plays a key role in both deceleration and energy recovery.

Regenerative braking converts the kinetic energy of the vehicle back into electrical energy, which is stored in the vehicle's battery. When the driver eases off the accelerator pedal, the electric motor functions as a generator, slowing the vehicle while charging the battery. This process improves the efficiency of EVs by recuperating energy that would otherwise be lost as heat in traditional friction brakes.

There are various implementations of one-pedal driving, each offering distinct features for controlling deceleration and braking. Some models provide a more aggressive deceleration profile, while others offer smoother, more gradual braking. For example, one system, referred to herein as ADM, provides an experience where, upon full release of the accelerator pedal, the vehicle applies significant regenerative braking force, decelerating rapidly and, in some configurations, bringing the vehicle to a stop without requiring the driver to touch the brake pedal. Another system, referred to herein as SCM, applies a less aggressive deceleration force upon pedal release, making it more suitable for drivers accustomed to traditional braking techniques.

In the SCM mode, the vehicle offers a complementary brake pedal that remains functional. This setup provides the driver with the flexibility to apply additional braking force as needed, especially during emergency stops or when approaching intersections or other stopping locations. For these implementations, regenerative braking slows the vehicle when the driver lifts their foot off the accelerator, but it is often insufficient to bring the vehicle to a complete stop, particularly when precise stopping is required at stop lines or behind other vehicles.

While one-pedal driving simplifies vehicle operation, drivers—especially novice users—may encounter difficulties when attempting to stop precisely at stop signs, traffic lights, or behind other vehicles. The challenge arises because the driver must judge the right moment to release the accelerator pedal, balancing the regenerative braking effect to ensure that the vehicle stops exactly at the desired point. This can lead to overshooting a stop line or requiring sudden braking if the driver misjudges the distance. Manual adjustments to the APO during driving, such as from a current location of the EV to the stop location, often result in a non-smooth deceleration profile, with fluctuating APO values caused by the driver repeatedly adjusting pedal pressure due to inexperience with one-pedal driving. As a result, the vehicle may experience jerky movements, making it challenging for the driver to stop precisely and smoothly at the intended stop location.

Implementations according to this disclosure provide enhanced control and ease of stopping in one-pedal driving systems by incorporating predictive deceleration management based on the driving environment and driver inputs (or “auto-deceleration” for short). These implementations detect upcoming stop locations—such as stop signs, traffic lights, or other stopped leading vehicles—using high-definition map data and vehicle sensors. Upon detecting a stop location, auto-deceleration generates a speed plan that ensures smooth deceleration by dynamically adjusting regenerative braking forces and coast torque based on factors such as the distance to the stop location, current speed, and road conditions.

By finely controlling coast torque alongside regenerative braking, auto-deceleration allows for smooth deceleration without sudden changes in speed, helping to ensure accurate stopping at designated locations. Coast torque refers to the resistance or drag generated by the motor or drivetrain of a vehicle when the accelerator pedal is released, but no active braking is applied. It simulates the natural slowing effect experienced in traditional combustion vehicles due to engine braking, allowing for smoother transitions between acceleration and deceleration without sudden changes in speed.

In addition to dynamically adjusting coast torque and deceleration, dynamic regenerative braking for stopping in one-pedal driving incorporates a personalized tuning method for deceleration at intersections using one-pedal driving functionality. This personalization enables the vehicle to arrive precisely at the stop line, with deceleration behavior tailored to the driver's preferences and driving habits. The predictive deceleration management (e.g., the dynamic regenerative braking) ensures a smooth and controlled driving experience, with the benefit of requiring relatively low computational power compared to modern learning methods such as neural networks or deep learning.

Implementations according to this disclosure can also include a voice-controlled human-machine interface (HMI) that provides the driver with real-time guidance. Through this interface, the driver receives instructions on when to release the accelerator pedal to allow the auto-deceleration to engage, when to apply the brake to achieve a complete stop, and when to take over in response to changes in traffic signals. Additionally, the HMI may incorporate a smart agent capable of modifying the deceleration algorithm to suit the driver's personalized preferences, thereby refining the system's behavior over time to better align with the user's needs.

In certain configurations, such as in the SCM, the driver is prompted to apply the brake pedal if regenerative braking alone is insufficient to bring the vehicle to a complete stop. This feedback not only enhances stopping control but also builds the driver's familiarity and confidence with one-pedal driving. Over time, the system supports adaptive learning by storing driver preferences for deceleration profiles and braking behavior, further improving the intuitiveness and comfort of the driving experience.

These implementations provide greater driving efficiency through optimized regenerative braking, improved energy recovery for enhanced battery range, and increased safety by ensuring reliable stopping at critical points on the road. By addressing the challenges of precise stopping in one-pedal driving, the disclosed system enhances both the usability and performance of EVs, delivering a smooth and intuitive driving experience for a wide range of drivers.

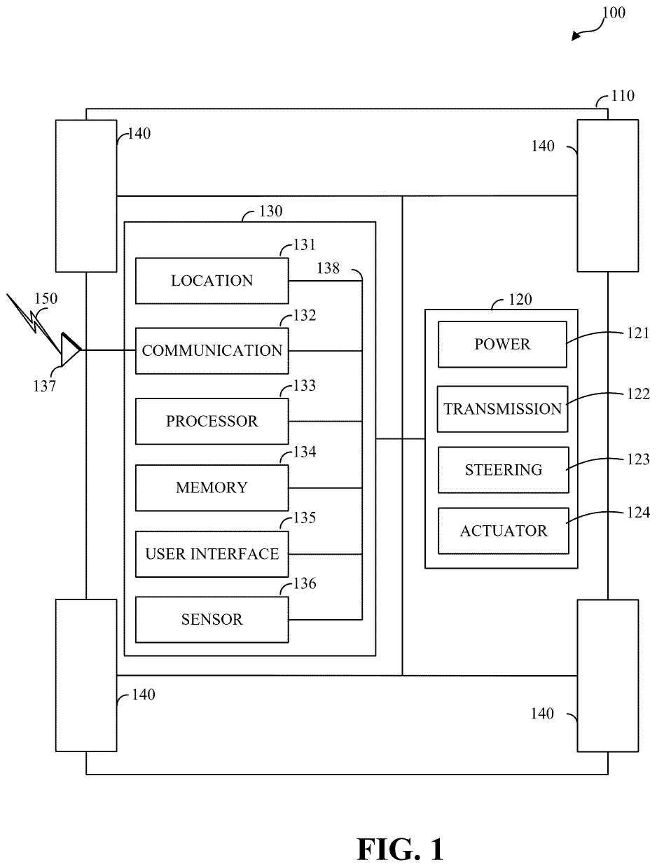

To describe some implementations in greater detail, reference is first made to examples of hardware and software structures used in dynamic regenerative braking for stopping in one-pedal driving, as described herein. FIG. 1 is a diagram of an example of a vehicle in which the aspects, features, and elements disclosed herein may be implemented. In the embodiment shown, a vehicle 100, which is an EV, includes various vehicle systems. The vehicle systems include a chassis 110, a powertrain 120, a controller 130, and wheels 140. Additional or different combinations of vehicle systems may be used. Although the vehicle 100 is shown as including four wheels 140 for simplicity, any other propulsion device or devices, such as a propeller or tread, may be used. In FIG. 1, the lines interconnecting elements, such as the powertrain 120, the controller 130, and the wheels 140, indicate that information, such as data or control signals, power, such as electrical power or torque, or both information and power, may be communicated between the respective elements. For example, the controller 130 may receive power from the powertrain 120 and may communicate with the powertrain 120, the wheels 140, or both, to control the vehicle 100, which may include accelerating, decelerating, steering, or otherwise controlling the vehicle 100.

The powertrain 120 shown by example in FIG. 1 includes a power source 121, a transmission 122, a steering unit 123, and an actuator 124. Any other element or combination of elements of a powertrain, such as a suspension, a drive shaft, axles, or an exhaust system may also be included. Although shown separately, the wheels 140 may be included in the powertrain 120.

The power source 121 includes an engine, a battery, or a combination thereof. The power source 121 may be any device or combination of devices operative to provide energy, such as electrical energy, thermal energy, or kinetic energy. In an example, the power source 121 includes an engine, such as an internal combustion engine, an electric motor, or a combination of an internal combustion engine and an electric motor, and is operative to provide kinetic energy as a motive force to one or more of the wheels 140. Alternatively or additionally, the power source 121 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy. Thus, in an example, the power source 121 includes a battery and electric motor that supplies kinetic energy as a motive force to one or more wheels. In purely electric configurations, power management is achieved through a motor controller that adjusts the electrical current supplied to the motor, rather than by controlling air or fuel intake, as in an internal combustion engine.

The transmission 122 receives energy, such as kinetic energy, from the power source 121, transmits the energy to the wheels 140 to provide a motive force. The transmission 122 may be controlled by the controller 130, the actuator 124, or both. The steering unit 123 may be controlled by the controller 130, the actuator 124, or both and control the wheels 140 to steer the vehicle. The actuator 124 may receive signals from the controller 130 and actuate or control the power source 121, the transmission 122, the steering unit 123, or any combination thereof to operate the vehicle 100.

In the illustrated embodiment, the controller 130 includes a location unit 131, a communication unit 132, a processor 133, a memory 134, a user interface 135, a sensor 136, and a communication interface 137. Fewer of these elements may exist as part of the controller 130. Although shown as a single unit, any one or more elements of the controller 130 may be integrated into any number of separate physical units. For example, the user interface 135 and the processor 133 may be integrated in a first physical unit and the memory 134 may be integrated in a second physical unit. Although not shown in FIG. 1, the controller 130 may include a power source, such as a battery. Although not shown in FIG. 1, the controller 130 may include an engine control unit (ECU) (e.g., engine control module) and a Proportion-Integral-Derivate (PID) controller. Although shown as separate elements, the location unit 131, the communication unit 132, the processor 133, the memory 134, the user interface 135, the sensor 136, the communication interface 137, or any combination thereof may be integrated in one or more electronic units, circuits, or chips.

The processor 133 may include any device or combination of devices capable of manipulating or processing a signal or other information now-existing or hereafter developed, including optical processors, quantum processors, molecular processors, or a combination thereof. For example, the processor 133 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 133 is operatively coupled with one or more of the location unit 131, the memory 134, the communication interface 137, the communication unit 132, the user interface 135, the sensor 136, and the powertrain 120. For example, the processor may be operatively coupled with the memory 134 via a communication bus 138.

The memory 134 includes any tangible non-transitory computer-usable or computer-readable medium, capable of, for example, containing, storing, communicating, or transporting machine readable instructions, or any information associated therewith, for use by or in connection with any processor, such as the processor 133. The memory 134 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof. For example, a memory may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

The communication interface 137 may be a wireless antenna, as shown, a wired communication port, an optical communication port, or any other wired or wireless unit capable of interfacing with a wired or wireless electronic communication medium 150. Although FIG. 1 shows the communication interface 137 communicating via a single communication link, a communication interface may be configured to communicate via multiple communication links. Although FIG. 1 shows a single communication interface 137, a vehicle may include any number of communication interfaces.

The communication unit 132 is configured to transmit or receive signals via a wired or wireless electronic communication medium 150, such as via the communication interface 137. Although not explicitly shown in FIG. 1, the communication unit 132 may be configured to transmit, receive, or both via any wired or wireless communication medium, such as radio frequency (RF), ultraviolet (UV), visible light, fiber optic, wireline, or a combination thereof. Although FIG. 1 shows a single communication unit 132 and a single communication interface 137, any number of communication units and any number of communication interfaces may be used. In some embodiments, the communication unit 132 includes a dedicated short-range communications (DSRC) unit, an on-board unit (OBU), or a combination thereof.

The location unit 131 may determine geolocation information, such as longitude, latitude, elevation, direction of travel, or speed, of the vehicle 100. In an example, the location unit 131 includes a GPS unit, such as a Wide Area Augmentation System (WAAS) enabled National Marine-Electronics Association (NMEA) unit, a radio triangulation unit, or a combination thereof. The location unit 131 can be used to obtain information that represents, for example, a current heading of the vehicle 100, a current position of the vehicle 100 in two or three dimensions, a current angular orientation of the vehicle 100, or a combination thereof.

The user interface 135 includes any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 135 may be operatively coupled with the processor 133, as shown, or with any other element of the controller 130. Although shown as a single unit, the user interface 135 may include one or more physical units. For example, the user interface 135 may include both an audio interface for performing audio communication with a person and a touch display for performing visual and touch-based communication with the person. The user interface 135 may include multiple displays, such as multiple physically separate units, multiple defined portions within a single physical unit, or a combination thereof.

The sensors 136 are operable to provide information that may be used to control the vehicle. The sensors 136 may be an array of sensors. The sensors 136 may provide information regarding current operating characteristics of the vehicle 100, including vehicle operational information. The sensors 136 can include, for example, a speed sensor, acceleration sensors, a steering angle sensor, traction-related sensors, braking-related sensors, steering wheel position sensors, eye tracking sensors, seating position sensors, or any sensor, or combination of sensors, which are operable to report information regarding some aspect of the current dynamic situation of the vehicle 100.

The sensors 136 include one or more sensors 136 that are operable to obtain information regarding the physical environment surrounding the vehicle 100, such as operational environment information. For example, one or more sensors may detect road geometry, such as lane lines, and obstacles, such as fixed obstacles, vehicles, and pedestrians. The sensors 136 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 136 and the location unit 131 are combined. Moreover, the sensor 136 can be or include an accelerator pedal position sensor (APPS) or throttle position sensor (TPS). It may then send this information to the controller 130, such as the ECU. The TPS may be located on the throttle body of the engine, and the TPS may send information to the ECU about the actual position of a throttle in the engine (e.g., the internal combustion engine). The APPS may monitor a position of an accelerator pedal (pedal) and how much the pedal is being pressed. The TPS may monitor position of the throttle in the engine. The throttle is essentially a valve that controls how much air can enter the engine. When a driver presses down on the accelerator pedal, the throttle opens more, allowing more air into the engine, which then allows for more fuel to be added, thus increasing power. When the driver releases the accelerator pedal, the throttle closes, reducing the amount of air (and therefore fuel) entering the engine, thus decreasing power.

Although not shown separately, the vehicle 100 may include a trajectory controller. For example, the controller 130 may include the trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller may output signals operable to control the vehicle 100 such that the vehicle 100 follows the trajectory that is determined by the trajectory controller. For example, the output of the trajectory controller can be an optimized trajectory that may be supplied to the powertrain 120, the wheels 140, or both. In some embodiments, the optimized trajectory can be control inputs such as a set of steering angles, with each steering angle corresponding to a point in time or a position. In some embodiments, the optimized trajectory can be one or more paths, lines, curves, or a combination thereof.

One or more of the wheels 140 may be a steered wheel that is pivoted to a steering angle under control of the steering unit 123, a propelled wheel that is torqued to propel the vehicle 100 under control of the transmission 122, or a steered and propelled wheel that may steer and propel the vehicle 100.

Although not shown in FIG. 1, a vehicle may include additional units or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

The vehicle 100 may be an EV, as described above. Moreover, the vehicle 100 may be equipped with one-pedal functionality, which is designed to enable a one-pedal driving experience. The one-pedal functionality allows for the control of acceleration, deceleration, stopping and holding of the vehicle using only the accelerator pedal as described above. Although not separately illustrated in FIG. 1, a vehicle with one-pedal functionality includes a control unit that enables and manages the one-pedal operations. This control unit may be integrated with other vehicle components and/or systems. For example, the controller 130 may include the one-pedal control unit.

The vehicle 100 may be an autonomous vehicle that is controlled autonomously, without direct human intervention, to traverse a portion of a vehicle transportation network. Although not shown separately in FIG. 1, an autonomous vehicle may include an autonomous vehicle control unit that performs autonomous vehicle routing, navigation, and control. The autonomous vehicle control unit may be integrated with another unit of the vehicle. For example, the controller 130 may include the autonomous vehicle control unit.

When present, the autonomous vehicle control unit may control or operate the vehicle 100 to traverse a portion of the vehicle transportation network in accordance with current vehicle operation parameters. The autonomous vehicle control unit may control or operate the vehicle 100 to perform a defined operation or maneuver, such as parking the vehicle. The autonomous vehicle control unit may generate a route of travel from an origin, such as a current location of the vehicle 100, to a destination based on vehicle information, environment information, vehicle transportation network information representing the vehicle transportation network, or a combination thereof, and may control or operate the vehicle 100 to traverse the vehicle transportation network in accordance with the route. For example, the autonomous vehicle control unit may output the route of travel to the trajectory controller to operate the vehicle 100 to travel from the origin to the destination using the generated route.

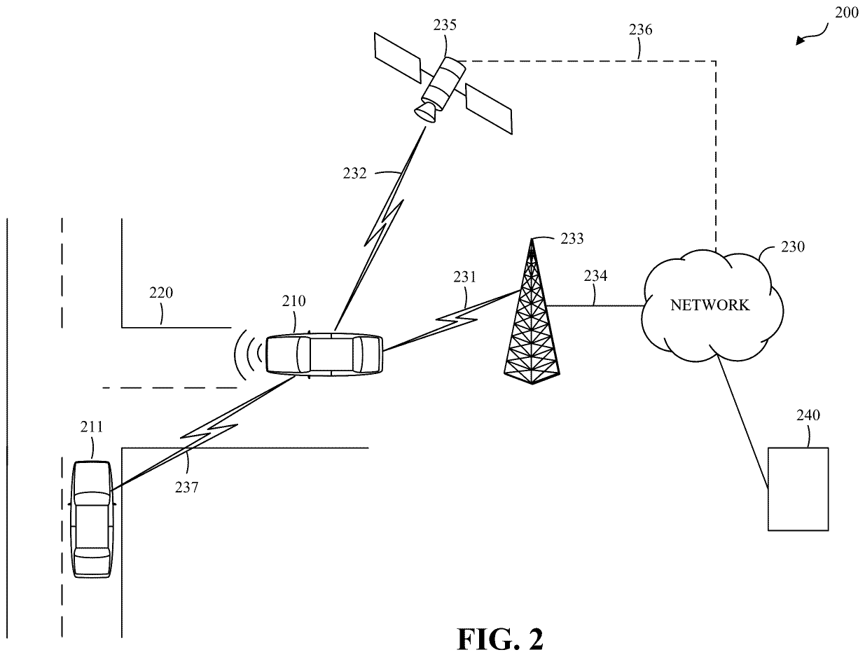

FIG. 2 is a diagram of an example of a portion of a vehicle transportation and communication system in which the aspects, features, and elements disclosed herein may be implemented. The vehicle transportation and communication system 200 may include one or more vehicles 210/211, such as the vehicle 100 shown in FIG. 1, which travels via one or more portions of the vehicle transportation network 220, and communicates via one or more communication networks 230. Although not explicitly shown in FIG. 2, a vehicle may traverse an off-road area.

The communication network 230 may be, for example, a multiple access system that provides for communication, such as voice communication, data communication, video communication, messaging communication, or a combination thereof, between the vehicle 210/211 and one or more communication devices 240. For example, a vehicle 210/211 may receive information, such as information representing the vehicle transportation network 220, from a communication device 240 via the communication network 230.

In some embodiments, a vehicle 210/211 may communicate via a wired communication link (not shown), a wireless communication link 231/232/237, or a combination of any number of wired or wireless communication links. As shown, a vehicle 210/211 communicates via a terrestrial wireless communication link 231, via a non-terrestrial wireless communication link 232, or via a combination thereof. The terrestrial wireless communication link 231 may include an Ethernet link, a serial link, a Bluetooth link, an infrared (IR) link, an ultraviolet (UV) link, or any link capable of providing for electronic communication.

A vehicle 210/211 may communicate with another vehicle 210/211. For example, a host, or subject, vehicle 210 may receive one or more automated inter-vehicle messages, such as a basic safety message (BSM), from a remote, or target, vehicle 211, via a direct communication link 237, or via the communication network 230. The remote vehicle 211 may broadcast the message to host vehicles within a defined broadcast range, such as 300 meters. In some embodiments, the vehicle 210 may receive a message via a third party, such as a signal repeater (not shown) or another remote vehicle (not shown). A vehicle 210/211 may define an interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The vehicle 210 may communicate with the communications network 230 via an access point 233. The access point 233, which may include a computing device, is configured to communicate with a vehicle 210, with a communication network 230, with one or more communication devices 240, or with a combination thereof via wired or wireless communication links 231/234. For example, the access point 233 may be a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit here, an access point may include any number of interconnected elements.

The vehicle 210 may communicate with the communications network 230 via a satellite 235, or other non-terrestrial communication device. The satellite 235, which may include a computing device, is configured to communicate with a vehicle 210, with a communication network 230, with one or more communication devices 240, or with a combination thereof via one or more communication links 232/236. Although shown as a single unit here, a satellite may include any number of interconnected elements.

A communication network 230 is any type of network configured to provide for voice, data, or any other type of electronic communication. For example, the communication network 230 may include a local area network (LAN), a wide area network (WAN), a virtual private network (VPN), a mobile or cellular telephone network, the Internet, or any other electronic communication system. The communication network 230 uses a communication protocol, such as the transmission control protocol (TCP), the user datagram protocol (UDP), the internet protocol (IP), the real-time transport protocol (RTP) the HyperText Transport Protocol (HTTP), or a combination thereof. Although shown as a single unit here, an electronic communication network may include any number of interconnected elements.

The vehicle 210 may identify a portion or condition of the vehicle transportation network 220. For example, the vehicle includes at least one on-vehicle sensor, like the sensor 136 shown in FIG. 1, which may be or include a speed sensor, a wheel speed sensor, a camera, a gyroscope, an optical sensor, a laser sensor, a radar sensor, a sonic sensor, or any other sensor or device or combination thereof capable of determining or identifying a portion or condition of the vehicle transportation network 220.

The vehicle 210 may traverse a portion or portions of the vehicle transportation network 220 using information communicated via the communication network 230, such as information representing the vehicle transportation network 220, information identified by the at least one on-vehicle sensors 209, or a combination thereof.

Although FIG. 2 shows a vehicle transportation network 220, one communication network 230, and one communication device 240, for simplicity, any number of networks or communication devices may be used. The vehicle transportation and communication system 200 may include devices, units, or elements not shown in FIG. 2. Although the vehicle 210 is shown as a single unit, a vehicle may include any number of interconnected elements.

Although the vehicle 210 is shown communicating with the communication device 240 via the communication network 230, the vehicle 210 may communicate with the communication device 240 via any number of direct or indirect communication links. For example, the vehicle 210 may communicate with the communication device 240 via a direct communication link, such as a Bluetooth communication link.

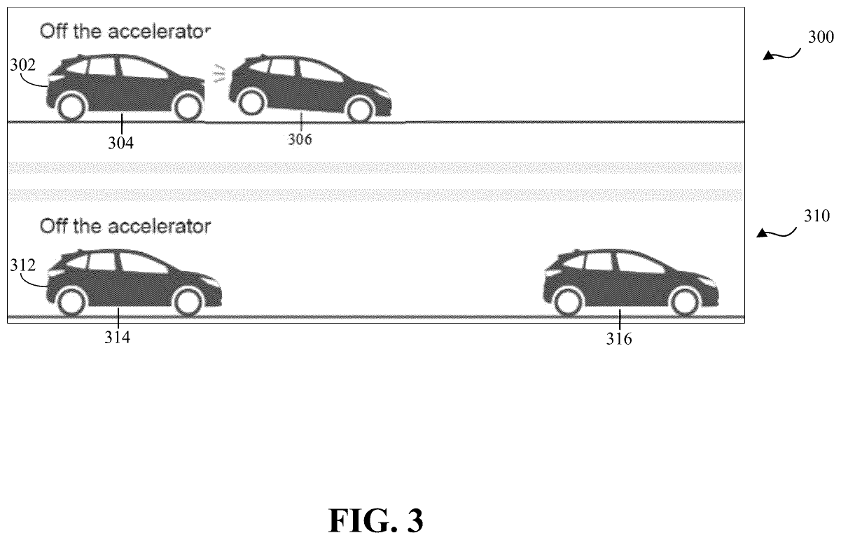

FIG. 3 briefly illustrates the default operations of ADM 300 and SCM 310 in the context of one-pedal driving, with a focus on the behavior when the accelerator pedal is fully released.

In the ADM 300, when the driver of a vehicle 302 at position 304 releases the accelerator pedal, the motor's regenerative braking system engages to generate a strong deceleration force significantly greater than that of a conventional engine brake causing the vehicle 302 to stop at a location 306. This high level of deceleration allows the driver to control the vehicle's speed almost entirely through the accelerator pedal, reducing reliance on the brake pedal. The deceleration force varies depending on the extent to which the accelerator pedal is released. A small release results in a mild deceleration, whereas a full release produces firm deceleration, as seen with the vehicle 302. The deceleration force may be based on the speed of the vehicle 302. At higher speeds, the deceleration is moderated to facilitate smoother cruising, while at lower speeds, the regenerative braking force is more aggressive to allow for quicker slowdowns.

Although the ADM 300 offers significant energy recovery by generating regenerative power to recharge the vehicle's battery, it can present challenges in certain driving scenarios. For instance, when approaching a stop line of a stop sign or a traffic light, the strong deceleration may cause the vehicle to slow more abruptly than intended, requiring the driver to carefully adjust the accelerator pedal to ensure a smooth stop. This task can be particularly difficult for novice drivers, who may struggle to stop precisely at the intended point without over-correcting their input.

In contrast, the SCM 310 offers a smoother and more gradual deceleration experience, as illustrated by the transition of a vehicle 312 from a position 314 to a position 316 when the accelerator pedal is fully released. This mode provides a driving experience more similar to that of a traditional internal combustion engine vehicle, making it easier for drivers accustomed to conventional driving techniques to adapt. In the SCM 310, releasing the accelerator pedal engages regenerative braking, but the deceleration force is less aggressive than that of the ADM 300, resulting in a more gradual reduction in speed. Unlike the ADM 300, the SCM 310 does not bring the vehicle to a complete stop solely through regenerative braking. Instead, the driver must use the brake pedal to stop the vehicle precisely, especially when navigating intersections, approaching stop lines, or following other vehicles closely.

The gradual deceleration provided by SCM 310 can pose challenges when precise stopping is required. Drivers must anticipate the appropriate moment to transition from releasing the accelerator to applying the brake pedal to achieve a smooth and accurate stop. Inconsistent input during the transition between accelerator release and brake application may cause jerky vehicle movements, as small adjustments to the pedal position may inadvertently lead to over-correction or delayed braking. This variability can make it difficult for drivers to consistently achieve smooth and precise stops at designated points, particularly in stop-and-go traffic or when navigating complex intersections.

Both the ADM 300 and the SCM 310 require a degree of driver skill to achieve smooth and precise stops, particularly in situations that demand careful control, such as intersections or heavy traffic. These default behaviors highlight the differences in deceleration characteristics between the two modes and underscore the challenges associated with stopping at precise locations, such as stop lines or behind other vehicles.

These challenges demonstrate the need for an accelerator behavior in one-pedal driving that adaptively controls regenerative braking, such that when the driver removes their foot from the accelerator, the vehicle can be controlled to stop at or come close to a desired stop location without causing abrupt or jerky movements.

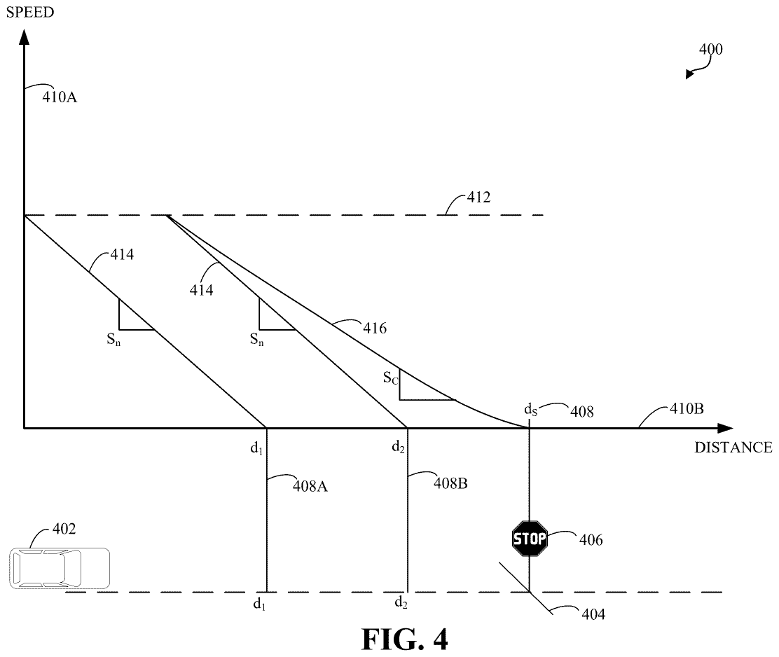

FIG. 4 illustrates a scenario 400 for dynamic regenerative braking in one-pedal driving, demonstrating how the braking behavior of a vehicle 402 is dynamically adjusted to stop at a desired stop line 404. In the illustrated scenario, the vehicle 402 is configured with the SCM, but a similar description applies when the vehicle 402 is configured with the ADM. In this scenario, the vehicle 402 is required to stop at the stop line 404, such as in response to the presence of a stop sign 406. The stop line 404 may also correspond to other scenarios, such as the presence of a red traffic light, a need to turn right or left at an intersection, or to stop behind another vehicle.

The vehicle 402 is to come to a complete stop at a final distance 408, denoted as ds, from its current location. A plot in FIG. 4 illustrates the relationship between the current speed of the vehicle 402 (plotted on an axis 410A) and the distance at which the vehicle 402 will stop (plotted on axis 410B) if the accelerator pedal is fully released at the current location of the vehicle 402. A default deceleration behavior, given that the vehicle 402 is currently traveling at a speed 412, is represented by a relationship 414, which is shown as a linear slope Sₙ. Although the plot represents the behavior as linear, it is not restricted to this pattern and may vary depending on other default regenerative braking behavior.

Under the default behavior represented by the relationship 414, if the accelerator pedal were fully released at a first position along the route, the vehicle 402 will decelerate and stop at or close to a first distance 408A (denoted as d₁) from that position. Similarly, if the accelerator pedal were fully released at a second position farther along the route, the vehicle 402 will decelerate and stop at or close to a second distance 408B (denoted as d₂) from that position. In both cases, the default behavior does not guarantee that the vehicle 402 will stop precisely at or sufficiently close to the stop line 404.

To address this, dynamic regenerative braking (i.e., auto-deceleration), when activated, adjusts the coast torque of the vehicle 402 to ensure it approaches the stop line 404 accurately. This behavior is represented by a curve 416 in the plot. The curve 416 illustrates a dynamic adjustment of deceleration forces, where the slope S_{c} (referred to as the coast slope) is modulated to fine-tune the deceleration profile. Although the term “deceleration profile” may be used, it should be appreciated that the deceleration profile may also include accelerations, such as when the vehicle 402 may be moving too slowly to reach the stop line 404 only based on regenerative braking. In such cases, slight increases in speed may be necessary.

The slope S_{c} lies between the aggressive deceleration experienced in ADM and the smoother deceleration provided by SCM, ensuring a balanced braking force. Specifically, the coast slope S_{c} is adjusted within the range where ADMₛₗₒₚₑ≤S_{c}≤SCMₛₗₒₚₑ, offering more control than standard coast mode while maintaining smooth deceleration for improved driver comfort.

As further described herein, dynamic regenerative braking incorporates several inputs and outputs. Inputs to the system include the vehicle's APO, which reflects the driver's pedal release behavior, and map data containing approximate stop line information. Based on these inputs, the system produces an adjusted coast deceleration profile that ensures the vehicle smoothly reaches the stop line 404. The system may also output an HMI feedback to guide the driver during deceleration.

The HMI feedback may include prompts or alerts instructing the driver when to release the accelerator pedal to allow the dynamic braking system to engage. In certain situations, the feedback may also prompt the driver to apply the brake pedal manually if regenerative braking alone is insufficient to bring the vehicle to a complete stop. This combination of coast torque adjustment and HMI interaction ensures that the vehicle 402 achieves a controlled and predictable deceleration, arriving either precisely at or very close to the stop line 404.

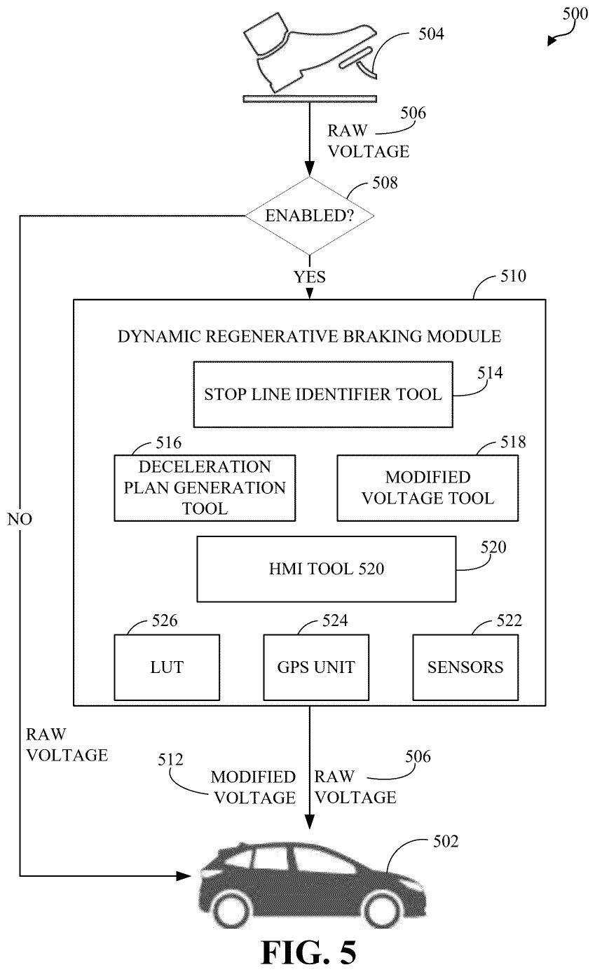

FIG. 5 illustrates a block diagram of a system 500 for dynamic regenerative braking for stopping in one-pedal driving. The system 500 includes a vehicle 502, which can be the vehicle 100 of FIG. 1. The vehicle 502 incorporates an accelerator pedal 504, which outputs a raw voltage 506 based on the driver's input. At a decision block 508, the system 500 determines whether dynamic regenerative braking is enabled. If enabled, the raw voltage 506 is processed by a dynamic regenerative braking module 510, which may (or may not) modify the raw voltage 506 to generate a modified voltage (e.g., the output voltage 512) or allow the raw voltage 506 to pass through unaltered.

The activation of dynamic regenerative braking can be configured by the driver through the user interface of the vehicle 502. When dynamic regenerative braking is not enabled, the raw voltage 506 follows the vehicle's default one-pedal driving behavior. The dynamic regenerative braking module 510 is designed to optimize the vehicle's stopping performance by actively identifying stop lines or other stop locations within a threshold distance in the direction of travel. This threshold varies based on the speed of the vehicle.

The dynamic regenerative braking module 510 includes tools, such as programs, subprograms, functions, routines, subroutines, operations, executable instructions, circuits, and/or the like for, inter alia and as further described herein, dynamic regenerative braking for stopping in one-pedal driving. The dynamic regenerative braking module 510 encompasses several key tools, including a stop line identifier tool 514, a deceleration plan generation tool 516, a modified voltage tool 518, and an HMI tool 520.

The stop line identifier tool 514 utilizes data from vehicle sensors 522 and a GPS unit 524 to determine the presence of stop lines (e.g., stop locations). A stop line or stop location is a designated boundary along the path of the vehicle 502, such as at an intersection, traffic light, or stop sign, where the vehicle is to come to a complete stop to comply with traffic rules or road conditions. The GPS unit 524 provides precise lane-level information (such as at centimeter-level accuracy), aiding in accurate localization and decision-making. The vehicle sensors 522, which may be or include a camera sensor, capture data on surrounding objects and traffic signals. Images from the vehicle sensors 522 may be processed to determine, for example, whether an upcoming traffic light, within the threshold distance, is red or green, thus informing the decision-making process of the dynamic regenerative braking module 510.

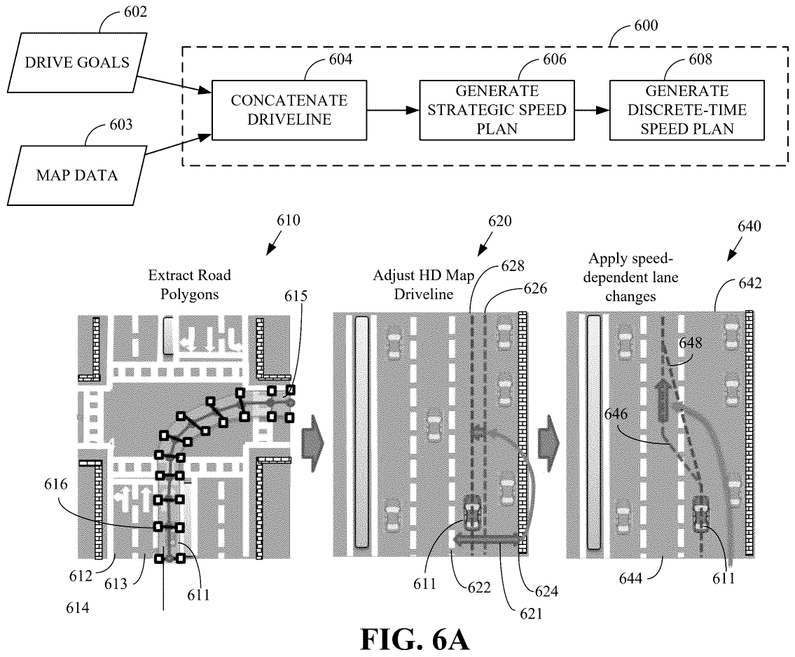

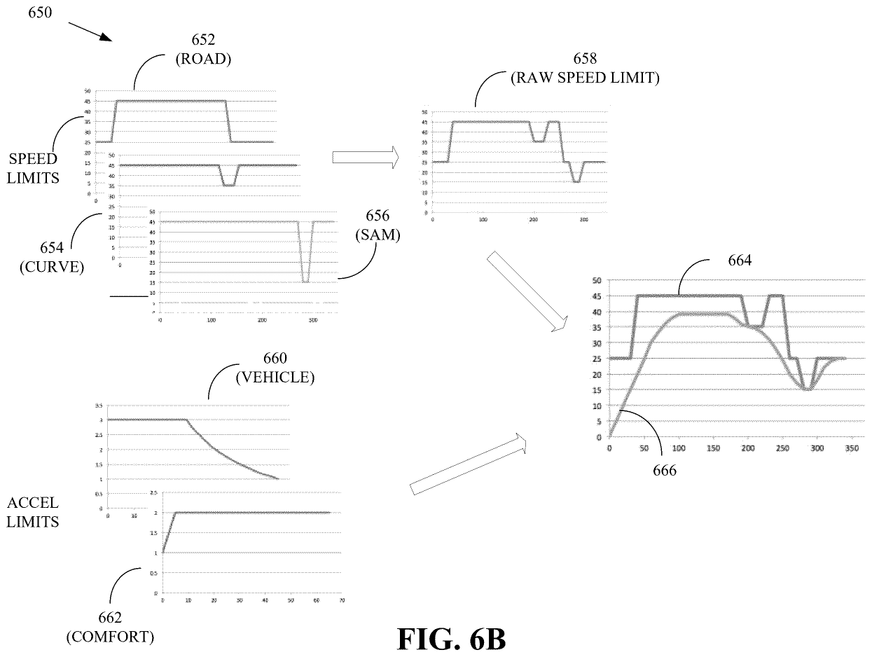

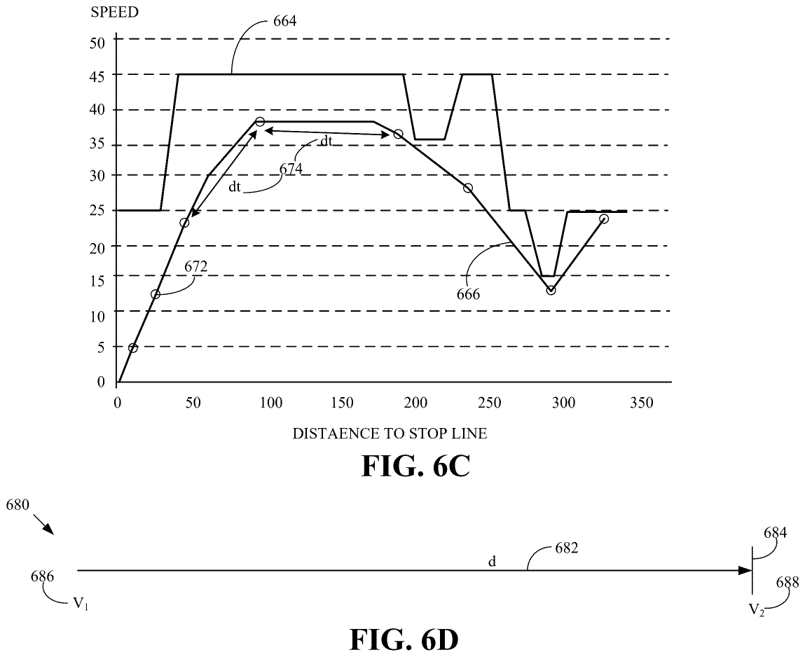

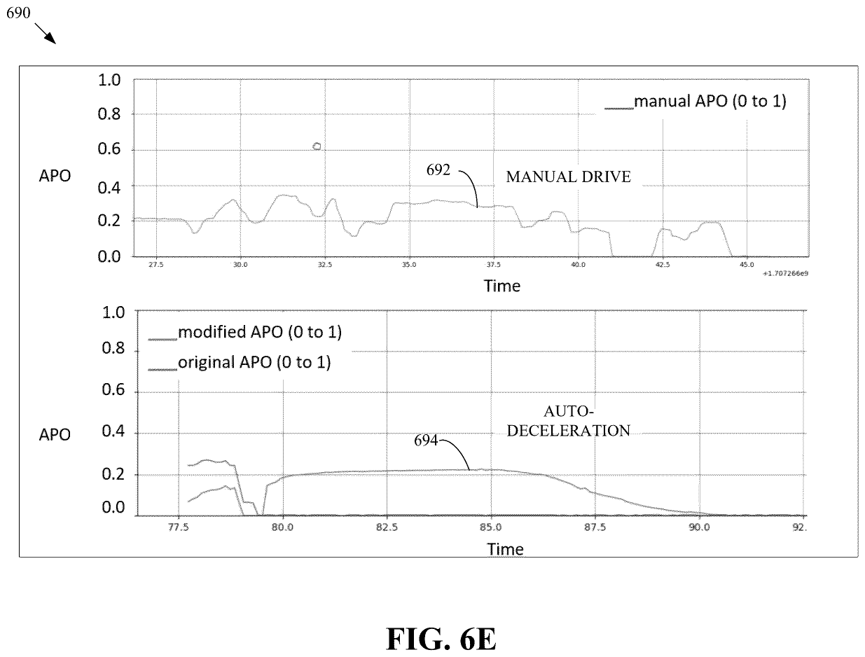

The deceleration plan generation tool 516 calculates an optimal speed plan, adjusting both acceleration and deceleration to ensure smooth and efficient stops. The speed deceleration plan generation tool 516 tool considers various parameters, such as the current speed, the distance to the stop line, and traffic conditions, to generate a comprehensive speed plan from which a deceleration plan (more accurately, an acceleration/deceleration plan) is then generated for controller the vehicle. The deceleration plan generation tool 516 is further described with respect to FIGS. 6A-6E.

The modified voltage tool 518 dynamically adjusts the raw voltage 506 to a new voltage level using a look-up table (LUT) 526. The modified voltage tool 518 ensures that the output voltage 512 reflects the desired torque and speed adjustments required for efficient deceleration towards the stop line. The LUT 526, also referred to as the Voltage Look-Up table, is distinct from a deceleration look-up table that is further described herein.

The LUT 526 is used to convert an APO value into a vehicle-readable voltage value, which is essential in the one-pedal driving system. The x-axis (or first dimension) of this table contains APO values, while the y-axis (or second dimension) contains manually recorded voltage values corresponding to those APO levels. When the auto-deceleration algorithm determines (e.g., computes) a deceleration value based on the deceleration LUT, the deceleration value undergoes a series of transformations: from acceleration/deceleration to force, then to torque. Using the torque and current speed, an APO value is calculated through an inverse APO-Torque map. This APO value is subsequently mapped to a corresponding voltage using the APO-Voltage LUT (e.g., the LUT 526), producing a motor voltage that guides the vehicle to the desired stop position.

By contrast, the deceleration LUT accepts the current distance to the stop line as its input and outputs a corresponding deceleration value. This LUT includes an array of distances to the stop line along the x-axis and pre-determined deceleration values on the y-axis. When a specific distance to the stop line is provided, the deceleration LUT interpolates and returns an appropriate deceleration value. This deceleration LUT is generated based on the speed plan illustrated in FIG. 6C, ensuring that the vehicle decelerates smoothly and appropriately as it approaches the stop location.

The HMI tool 520 is used to interact with the driver through any number of modalities. For example, the HMI tool 520 may output prompts on a touch screen display of the vehicle 402 and receive driver responses via the touch screen display. The HMI tool 520 may interact with the driver via a voice modality to obtain voice-based feedback.

The HMI tool 520 may provide instructions on when the driver is to release the accelerator pedal or apply the brake pedal, ensuring a smooth transition between automated control (e.g., auto-deceleration) and manual input. The HMI tool 520 also gathers feedback from the driver, which can be used to fine-tune the auto-deceleration algorithms of the dynamic regenerative braking module 510 for future driving scenarios, enhancing personalization and adaptability.

The raw voltage 506 generated by the accelerator pedal 504 may be an analog signal that represents the driver's input. In some implementations, the dynamic regenerative braking module 510 may convert this signal into a modulated Pulse Width Modulation (Mod PWM) signal and subsequently into a modified analog signal. The conversion from an analog input to PWM offers several advantages. PWM signals are particularly effective for use with control algorithms, including the LUT 526, as they allow for precise regulation of voltage and enable efficient mapping between accelerator input and the desired vehicle behavior. Additionally, PWM facilitates the modulation of torque and deceleration levels with greater precision, enhancing the vehicle's responsiveness to driver input.

A benefit of converting to PWM is that it allows for quick adjustment and fine-tuning of outputs in real time, with minimal computational overhead. For example, the dynamic regenerative braking module 510 may use an RC filter, consisting of a resistor (R) and capacitor (C), to filter specific frequency components from the analog raw voltage signal (e.g., the raw voltage 506). The RC filter also eliminates potential large signal lags, ensuring a response time within a few milliseconds (e.g., less than 5 milliseconds), thereby providing seamless transitions between the default driving modes and one-pedal driving at zero APO. Once the PWM-based adjustments are complete, the dynamic regenerative braking module 510 converts the modulated PWM signal back into a modified analog signal. This modified analog signal reflects the intended driving behavior, ensuring smooth and precise vehicle control that aligns with the driver's expectations.

FIGS. 6A-6E illustrate generating a deceleration plan by the deceleration plan generation tool 516 of FIG. 5. As mentioned above, the deceleration plan generation tool 516 first generates a speed plan from which it then obtains a deceleration plan. FIG. 6A includes a flowchart of a technique 600 for generating a speed plan. The speed plan can be generated by the plan generation tool 516. The technique 600 receives (e.g., generates) drive goals 602 and map data 603. The technique 600 can be executed by the by a dynamic regenerative braking module 510 in response to the stop line identifier tool 514 of FIG. 5 determining that a stop line is coming up. Thus, the technique 600 is used to determine a plan for stopping the vehicle 502 at or close to the stop line from the current location of the vehicle 502. The technique 600 includes at least the steps of concatenating 604 a driveline, generating 606 a speed plan, and generating 608 a discrete-time speed plan.

At a high level, concatenating 604 the driveline includes dividing a drive line into discrete polygons. The information on which the drive line to concatenate is given by the drive goals 602 and the map data 603. The drive goals 602 may be obtained by a lane level planning module of the vehicle. In some implementations, the lane level planning module can be part of the dynamic regenerative braking module 510 of FIG. 5. The lane level planning module can generate a plan for which road segments may be used between a current location of the vehicle to the stop line. Generating 606 the speed plan includes, after dividing the drive line into discrete polygons, getting the speed limit from the map data 603 for a particular road; generating for the next few hundred meters raw speed limits and distances for all the lanes ahead of the vehicle position; and adding acceleration limits when the speed increases or decreases. After getting the raw speed limits, acceleration limits are added to tune the speed plan. By optimizing the raw speed limits along the path with acceleration limits, a smooth speed plan is thus generated. Generating 608 the discrete-time speed plan includes setting a constant time step or time interval, dt, and getting a discrete-time speed plan; generating a discrete deceleration plan from the discrete-time speed plan; and generating a look-up table for deceleration plan and distance to stop line.

The drive goals 602 can represent, for example, a series of lane selections and speed limits that connect a first location (e.g., the current location of the vehicle 502) to a second location (e.g., the stop location). The drive goals can be based on contextual information derived from a state of the vehicle 502, such as whether the driver intends to turn right, turn left, or go straight. Whether the driver intends to turn left or right can be determined based on whether the turning signal is on or off; whether a destination of travel is set and the vehicle 502 is being driven according to a route to the destination; or whether the vehicle 502 is in a turning lane.

A drive goal of the drive goals 602 can be “starting at location x, travel on a lane having a certain identifier (e.g., lane with an identifier that is equal to A123) while respecting speed limit y.” In some implementations, the technique 600 can receive a trajectory that accomplishes the sequence of the drive goals 602. In some implementations, the technique 600 itself generates the trajectory.

A coarse driveline may be generated from the current location to the stop line. The driveline can be thought of as the line in the road over which the longitudinal axis of the vehicle 502 coincides as the vehicle 502 moves along the road. The driveline is coarse, at this point, and may contain lateral discontinuities such as when directed to transition laterally between adjacent lanes. The driveline at this point is also not yet adjusted for objects encountered by the AV, as further described below. The driveline data can be received from the map data 603. The map data 603 is data from a high-definition (i.e., high-precision) map. The map data 603 can include accurate information regarding a vehicle transportation network to within a few centimeters. For example, the map data 603 can include details regarding road lanes, road dividers, traffic signals, traffic signs, speed limits, and the like.

Coarse-driveline concatenation is now illustrated. In a view 610, a vehicle 611 is in a rightmost lane 614 of a three-lane road that includes lanes 612-614. Note that the view 610 is an example of a left-hand traffic system (i.e., the traffic in the lanes 612-614 moves from the bottom towards the top of FIG. 6). In this example, it may have been determined that the driver intends to turn right onto lane 615 of a one-lane road.

In some situations, the driveline of the vehicle 611 may not coincide with the centerline of a lane or road. For example, the lane 615 may be extra-wide to accommodate parking spaces along the left side of the lane 615. In another example, it may be found that most drivers prefer to drive slightly left of the centerline. As such, the driveline of the vehicle 611 is to be set to the left of the centerline of the lane 615. As such, at 604, concatenating the driveline includes determining the geometry of the lanes to determine the driveline given the lane geometry (e.g., the lane width). For example, when there is a turn in the coarse driveline, it is determined where the driveline is to be moved (i.e., off the lane centerline) based on the width of the lane, the turning direction (e.g., right or left), the turning angle, and/or the turning speed. That is, the driveline can be set based on the centerline identified in the map data 603. In an example, the driveline can be set based on the lane width.

To set the driveline, the geometry of lanes along the coarse driveline is determined. In an example, the geometry is determined for a certain distance (e.g., 100 meters, 200 meters, 300 meters, etc.) along the coarse driveline. To determine the geometry, polygons, such as a polygon 616 along the coarse driveline, are determined. The polygons can be used to define lane boundaries.

A view 620 illustrates determining the driveline (i.e., a coarse driveline) based on a width 621 of a lane. A right edge 624, a left edge 622, and a centerline 626 of a lane along which the vehicle 611 is traveling can be obtained from the HD map. The driveline 628 (i.e., the coarse driveline) is determined based on the width 621. As such, the driveline 628 is shifted from the centerline 626.

A view 640 illustrates a speed-dependent lane change. In an example, the technique 600 provides that the vehicle 611, traveling along a lane 642, is to be next in a lane 644, for example, because the lane 642 ends or because the vehicle 611 is to turn left. As such, the vehicle 611 is to move from the lane 642 to the lane 644 at some point. A lane transition time may then be determined. The transition can be speed dependent.

In an example, the technique 600 may determine that at a point X along the coarse driveline, the vehicle 611 will be moving at a speed Y. In a case where the vehicle 611 is moving at a low speed (e.g., 35 MPH), the transition can be slow. Accordingly, the path to move from the lane 642 to the lane 644 can be as shown by a path 646. On the other hand, if the vehicle 611 is traveling at a high speed (e.g., 65 MPH), the path to switch lanes requires a longer distance, as shown by a path 648.

The time required to follow the paths 646 and 648 can be the same. However, the distance is different. The distance required for the lane transition when the vehicle 611 is traveling at a first speed is longer than the distance required when the vehicle 611 is traveling at a second speed that is slower than the first speed.

FIG. 6B is an example 650 of determining a speed plan. The example 650 illustrates examples of inputs that can be used in determining a speed plan 664 and a smooth speed plan 666 therefrom. In the example 650, speed limits inputs and acceleration limits inputs can be used. The speed limits can include at least one of road speed limits 652, curvature speed limits 654, and seamless autonomous mobility (SAM) data 656. The acceleration limits can include vehicle acceleration limits 660 and comfort limits 662. The speed limits and/or the acceleration limits can include more, fewer, or other inputs.

The road speed limits 652 can be the road speed limits, such as those posted on speed limit signs (e.g., 20 MPH, 65 MPH, etc.). In an example, the road speed limits 652 can be obtained from an HD map. The curvature speed limits 654 can be data relating vehicle speed to a curvature of a turn, such as a turn along the coarse driveline of the vehicle. Alternatively, the curvature speed limits 654 can only provide road curvature information (e.g., the turning radius of a curve). The curvature speed limits 654 can be limits on the lateral acceleration of the vehicle. As such, the speed plan can include decreased vehicle speeds, consistent with the curvature speed limits 654, when the vehicle curves.

The SAM data 656 can be data gathered (such as in a cloud-based system) from vehicles (autonomous or otherwise). The SAM data 656 can enable vehicles to operate safely and smoothly on the road. In an example, the SAM data 656 can include vibration data collected from vehicles along a portion of a road. The vibration data can correlate vibration levels and speeds at different portions of the road. In an example, the vibration data may indicate, for a certain road location, an unacceptable level of vibration (for example, due to a speed bump at the portion of the road) when a vehicle is traveling above a certain speed. As such, to minimize the impact of the vibration, the vehicle is to be slowed down (below the certain speed) at the portion of the road. In an example, the SAM data 656 can be received by the vehicle from a central sever, such as the one or more communication devices 240, the server computing device 234, or some other network device. In an example, the SAM data 656 can be data accumulated from other vehicles within a certain time period (e.g., 1 minute, 10 minutes, 20 minutes, etc.) of the vehicle arriving at that location. In an example, the vehicle can pull the SAM data 656. In another example, the SAM data 656 can be pushed to the vehicle based on the vehicle reporting its location to a server that provides the SAM data 656.

The road speed limits 652, the curvature speed limits 654, and the SAM data 656 can be combined to provide raw speed limits 658. In an example, for each location of certain locations along the coarse driveline (e.g., every 5 meters, 10 meters, etc.), the minimum of the speed of the road speed limits 652 at that location, the speed of the curvature speed limits 654 at that location, and the speed of the SAM data 656 at that location is used as the speed of the raw speed limits 658 at that location.

The vehicle acceleration limits 660 can be vehicle acceleration limits that are due to the torque and power of the vehicle. The comfort limits 662 includes human comfort limits regarding acceleration, such as: How fast do the occupants of the vehicle want to the vehicle to accelerate or decelerate?

The raw speed limits 658, the vehicle acceleration limits 660, and the comfort limits 662 can be combined to provide the speed plan 664. The speed plan 664 is then smoothed out to generate the smooth speed plan 666.

At a location along the coarse driveline, the minimum of the road speed limits 652, the curvature speed limits 654, and the seamless autonomous mobility SAM data 656 can be used as the speed limit of the AV. The vehicle acceleration limits 660 and the comfort limits 662 relate acceleration to speed. As such, and in an example, the vehicle acceleration limits 660 and the comfort limits 662 can be combined by finding the minimum of the two maximum curves (comfort, speed). As such, at low speed, comfort can limit the maximum acceleration of the vehicle; whereas at high speed, the acceleration limits (e.g., the power) of the vehicle can limit the acceleration of the vehicle. A speed profile can be generated by solving for the fastest speed profile along the coarse driveline that satisfies the constraints on speed (speed limit at any given location along the driveline) and acceleration (acceleration limit at any given speed).

Inputs other than those described above can also be used to calculate the speed plan 664. For example, one or more of road mu, minimum cruise times, neighborhood type, or other inputs can be used. Road mu relates to the road slipperiness, such as due to ice, rain, slope, etc.

A minimum cruise time relates to the minimum length of time that the speed of the AV can be set to a constant speed. For example, assume that a segment of a road is 500 meters long and that the speed limit on that segment is 45 MPH. Additionally, assume that, given a motion model of the vehicle, 250 meters are required for the vehicle to reach the speed limit of 45 MPH from a stopped position, and 250 meters are required for the vehicle to be stopped given a current speed of 45 MPH. If the vehicle were at a stopped position at the beginning of the road segment and the vehicle is to be stopped again at the end of the road segment, then as soon as the vehicle reaches the speed limit of 45 MPH, the vehicle would have to start decelerating. Such speed profile may not be desirable and/or natural for occupants of the vehicle. As such, a minimum cruise time can indicate, for example, that a speed must be maintained for the minimum cruise time (e.g., 3 seconds) before the vehicle can start decelerating (or accelerating). As such, a more natural speed profile can be provided.

The neighborhood type can be used to model normal human driving behaviors, which may depend on the type of neighborhood that the vehicle is traversing through. For example, a human driver may drive below the posted speed limit in a residential neighborhood (e.g., where kids may be observed playing on the streets) and may drive at least at the posted limit in an industrial neighborhood, even though both neighborhoods may have the same posted speed limit.

FIG. 6C illustrates generating a deceleration plan from the smooth speed plan 666 of FIG. 6B. The smooth speed plan 666 is converted into a discrete-time deceleration plan by segmenting the plan into intervals of constant time steps 674 (dt). The value of dt may be predetermined; for example, the speed plan may be segmented into 1-second intervals. At each of these intervals, the speed from the speed plan is used to calculate the desired acceleration or deceleration at that specific point.

The process of generating the deceleration plan involves calculating acceleration values for various distances along the path of the vehicle up to the stop line. For example, at a distance of 25 meters, the desired speed might be 18 units (as shown by a point 672). Using the known time step dt, the required acceleration to achieve the desired speed at that distance is calculated. Similarly, for subsequent distances, such as 60 meters, the desired acceleration or deceleration is determined based on the speed plan and the vehicle's current state. The acceleration values are generated as part of the discrete deceleration plan, which is used to determine the optimal acceleration or deceleration required at each distance. That is, the series of acceleration values forms the discrete deceleration plan, which is then used to control the vehicle's acceleration or deceleration in real-time as it approaches the stop line.

FIG. 6C shows how each segment of the smooth speed plan 666 corresponds to discrete acceleration values, with acceleration values calculated at regular time intervals (dt) along the plan. The arrows 674 illustrate the time intervals (dt) between discrete time steps, with acceleration or deceleration generated based on changes in speed across each distance segment (dₓ) along the path to the stop line. This segmented deceleration plan forms the basis for controlling the vehicle's acceleration and deceleration behavior along the path.

The derived discrete acceleration values enable a deceleration plan that ensures that the vehicle is controlled to achieve the desired speed or stop location at the appropriate distance. For instance, if the speed plan indicates a stop line at 150 meters, the deceleration plan enables the vehicle to decelerate in a controlled manner, allowing it to approach, or come close to, zero speed at the stop line, depending on whether the vehicle is ADM or SCM, zero or close to zero speed exactly at the stop line. By using both the time step (dt) and distance-based segments (dx), the deceleration plan created matches the planned speed changes, whether accelerating to reach a speed limit or decelerating to a stop.

In an example, a LUT (a deceleration LUT) can be created for the deceleration plan, associating specific distances to the stop line with target deceleration values. This LUT enables efficient, real-time control of the vehicle. The deceleration plan guides the dynamic regenerative braking module 510 to smoothly execute acceleration and deceleration, ensuring the vehicle meets the strategic goals outlined in the original smooth speed plan 666. Specifically, the LUT is computed once, at the initiation of auto-deceleration, based on factors such as distance to the stop location and current vehicle speed. Once generated, this LUT remains fixed unless a change in the intended stop location is detected.

For example, if the dynamic regenerative braking module 510 initially anticipates that the driver will proceed straight through a traffic intersection and generates the deceleration plan accordingly, but the driver subsequently signals a left turn by moving into a left-turn lane, the stop scenario is re-evaluated. If the left-turn signal is red, a new deceleration plan is calculated and stored in the LUT, allowing the vehicle to approach and stop smoothly in accordance with the updated stop location. This functionality dynamically detects changes in traffic signals or lane positions to determine if an adjustment to the deceleration plan is necessary.

FIG. 6D illustrates an example 680 of generating a deceleration plan where map data is not available. In some implementations, where map data 603 is not available, and if a distance 682, denoted d, to a stop line 684 is known or can be estimated (such as by analyzing sensor data, such as LiDAR data or camera images), equations of motion can be used to derive the speed plan and a deceleration plan in a deceleration LUT. This approach may assume that the road is straight (e.g., there are no curvatures involved) and that there is no inclination of the roads.

A speed 686, denoted V₁, indicates the current speed of the vehicle and a speed 688, denoted V₂, indicates the desired speed at the stop line 684. If the vehicle is to stop at the stop line, V₂ is set to 0. The equation of motion V₂²=V₁²+2αd, α is the acceleration, which is calculated from the speed profile. This equation helps derive the acceleration needed over the given distance d to achieve the desired speed at the stop line. The discrete speed and acceleration values can be derived iteratively for each time step (dt). The iterative calculation uses Vₙₑₓₜ=V₁+dt*α_{now}. In these calculations, dt is a fixed time interval, such as 1 second. By iteratively applying this equation for each dt, a discrete speed and deceleration plan is generated based on the initial speed V₁ and the distance d to the stop line.

Once the deceleration plan is generated, a 2D LUT that maps distances to acceleration values can be generated. The LUT allows for smooth real-time adjustments of acceleration, even at small runtime intervals such as 0.01 seconds. The acceleration at any given moment is retrieved using equation (1) where d is the dynamic current distance (e.g., the current remaining distance to the stop line 684:

$$Currant Acceleration = LUT ( list Of Distances , list Of Accelertion Values , d ) \qquad ( l )$$

This method ensures that the acceleration values or each runtime interval t are smooth and accurate. When the stop line is used as the reference distance, with V₂=0, at the stop line, the acceleration can be calculated using equation (2):

$${a}_{now} = \frac{{V}_{2}^{2}}{2 d} \qquad ( 2 )$$

Using this acceleration, the system generates a deceleration plan that ensures the vehicle decelerates smoothly and arrives at the stop line 684 with the desired speed, providing vehicle control even in the absence of detailed map data.

FIG. 6E illustrates an APO comparison 690 between manual driving and auto-deceleration at an intersection, highlighting the differences in APO behavior when the deceleration is managed automatically by the dynamic regenerative braking module 510. A plot 692 shows the APO variation during manual driving, where the driver actively modulates the pedal position. Here, the APO fluctuates as the driver adjusts their pressure on the pedal to achieve desired deceleration or acceleration levels.

A plot 694, labeled “Auto-Deceleration,” illustrates the smoother APO profile achieved when the dynamic regenerative braking module 510 automatically controls deceleration using a predetermined speed plan and regenerative braking. In this mode, the APO transitions gradually towards zero as the vehicle approaches the stop line, eliminating the need for frequent manual adjustments by the driver.

The adaptive deceleration approach optimizes regenerative braking based on environmental context, such as proximity to intersections or stop signs. For example, if the system detects that the vehicle is approaching an intersection, the regenerative braking strength is adjusted to allow for smooth stopping without excessive deceleration. In contrast to traditional one-pedal driving modes, where regenerative braking can be abrupt and challenging to modulate, this approach provides a more intuitive driving experience by matching braking intensity to driving conditions, making regenerative braking more accessible and user-friendly for drivers in various contexts.

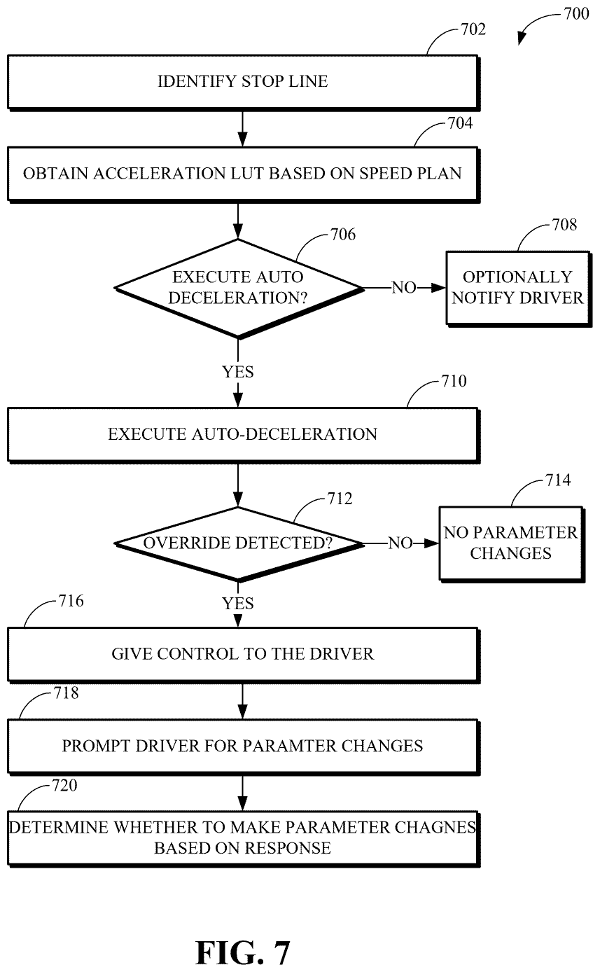

To further describe some implementations in greater detail, reference is next made to examples of techniques which may be performed for, inter alia, dynamic regenerative braking for stopping in one-pedal driving. FIG. 7 is a flowchart of an examples of a technique 700 that can be used for dynamic regenerative braking for stopping in one-pedal driving. The technique 700 can be executed using devices, such as the EVs (such as the vehicle 100 of FIG. 1), systems, hardware, and software described with respect to FIGS. 1-6C. The technique 700 can be performed, for example, by executing respective machine-readable programs or other computer-executable instructions, such as routines, instructions, programs, or other code. The steps, or operations, of the technique 700 or another technique, method, process, or algorithm described in connection with the implementations disclosed herein can be implemented directly in hardware, firmware, software executed by hardware, circuitry, or a combination thereof. The technique 700 can be executed by the dynamic regenerative braking module 510 of FIG. 5 of a vehicle. The technique 700 executes an auto-deceleration algorithm (which can be a shortened way to say that it dynamically applies regenerative braking for stopping at a stop line in one-pedal driving).

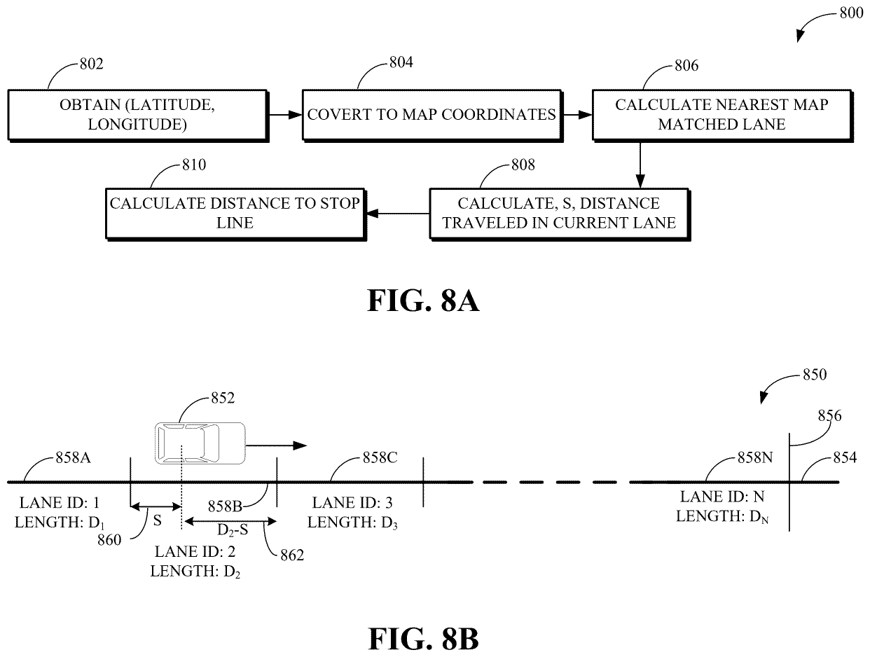

At 702, the technique 700 identifies a stop line, which may correspond to intersections, traffic lights, stop signs, or vehicles ahead (e.g., leading vehicles). This identification can be based on sensor data (such as from cameras or LiDAR) and/or high-definition map data to determine the stop location within a given path. Identifying the stop line includes identifying a distance to the stop line. Calculating the distance to the stop line is described with respect to FIGS. 8A-8B.

At 704, the technique 700 obtains an LUT based on a generated speed plan, the distance to the stop line, and, if applicable, a state of a traffic at the stop line. The speed plan can be generated as described above and provides a trajectory with target speeds over distance from a current location of the vehicle to the stop line. The LUT maps those distances to required acceleration (i.e., acceleration and deceleration) values.

At 706, the technique 700 determines whether to execute auto-deceleration based on conditions such as the distance to the stop line and the traffic signal's state. If the stop line is within a threshold distance—determined based on the speed limit (e.g., 70 meters for a 25 MPH zone or 150 meters for a 45 MPH zone) and the signal is red—the system will proceed with auto-deceleration. If auto-deceleration is not to be executed or is to stop executing, the technique 700 proceeds to 708; otherwise, the technique 700 proceeds to 710.

At 708, if auto-deceleration is not to be executed, the driver is optionally notified to continue using the accelerator pedal manually, maintaining control of the vehicle. This notification may be delivered via an HMI through visual or voice prompts. If the auto-deceleration was already executing, and the traffic light is determined to indicate that driver can proceed (e.g., if the light is green or flashing yellow), the technique 700 may output a notification to the driver essentially stating, “please, take control and keep driving. Auto-deceleration will disengage.”

At 710, auto-deceleration is executed. This involves retrieving target acceleration or deceleration values from the LUT, calculating target forces, converting the force and speed to an APO, and generating a corresponding output voltage to be applied to the motor to control the vehicle's speed. A notification can be output to driver essentially stating, “Auto-deceleration is ready to take over. Please remove your foot from the accelerator pedal.” When the driver removes their foot from the accelerator pedal, the vehicle is then controlled according to the output voltages calculated.

In some implementations, auto-deceleration is initiated based on the current speed limit to ensure optimal deceleration timing and driver comfort. At higher speeds, auto-deceleration is initiated earlier, allowing the driver sufficient time to adjust to the reduced speed gradually. Conversely, at lower speeds, auto-deceleration may begin closer to the stop line, as less time is required for speed adjustments. This dynamic timing approach enhances the adaptability of auto-deceleration to various driving conditions and driver preferences, supporting a smoother transition between speed control and the stopping process.

At 712, the technique 700 checks whether any driver overrides have been detected, such as the driver pressing the brake or accelerator pedal. While not specifically shown in FIG. 7, the steps 710 and 712 proceed in parallel. That is, while auto-deceleration is executing, the technique 700 monitors for overrides. The technique 700 continuously monitors the vehicle's Controller Area Network (CAN) bus (which is a communication network that enables real-time data exchange between the vehicle's sensors and control units) allowing it to detect any driver input overrides such as braking or acceleration. If no overrides are detected, the technique 700 proceeds to 714 where no changes are made. That is, the parameters in the LUT remain unchanged, and auto-deceleration continues according to the predefined plan.

On the other hand, if overrides are detected, the technique 700 proceeds to 716, where the driver is given control. That is, the auto-deceleration algorithm stops executing and the control of the vehicle is resumed based on the default behavior of the accelerator and brake pedals.

In some scenarios, the driver may choose to override the auto-deceleration algorithm to adjust the stopping position based on personal preferences or situational needs. For example, a driver may prefer to stop slightly past the stop line when preparing to make a right turn, allowing for better visibility of oncoming traffic. Alternatively, if preparing for a left turn, the driver might prefer to stop a bit before the stop line to maintain a safer distance from cross traffic. The system monitors these overrides-such as pressing the accelerator to proceed past the designated stop point or pressing the brake to halt before reaching it-via the CAN bus, allowing it to detect these driver preferences in real time. Based on these override inputs, the technique 700 can prompt the driver for feedback on whether to incorporate such adjustments into the deceleration profile, enabling the algorithm to adapt to the driver's unique preferences over time.

Accordingly, at 718, the driver is prompted for parameter changes through the HMI, facilitating personalized deceleration behavior. This interaction may include simple Yes/No questions designed to adjust deceleration parameters based on driver feedback, enhancing driver convenience and control. For example, if a brake override is detected, the HMI may ask the driver whether to increase deceleration by a factor (referred to as parameter_decel) of −0.1 m/s². On the other hand, if an acceleration override is detected, the HMI may prompt the driver whether to ‘increase the deceleration parameter.’ If the driver responds in the affirmative, the acceleration will be increased by a constant (the parameter_decel)+0.1 m/s2. In another example, the change to the deceleration parameter can be a function of the current speed limit of the road.

These adjustments can be applied as a parameter to the final acceleration or deceleration value derived from the deceleration plan, yielding a modified value. This final adjusted value proceeds through a sequence of transformations (e.g., acceleration/deceleration value+parameter_decel, force, torque, APO, and finally, voltage) thereby dynamically influencing the auto-deceleration behavior for optimal real-time control.

In some implementations, the application of this parameter adjustment may depend on contextual factors, ensuring situational adaptability. For instance, if the driver confirms a deceleration adjustment at a traffic light for a right-turn-on-red, the parameter modification may apply exclusively to this scenario rather than a standard stop-line approach, preserving the intended behavior of each deceleration context. Such adjustments may also adapt based on additional factors like traffic density or the presence of pedestrians, enabling the system to respond with increased caution when needed, such as preventing an over-extension into a right turn

At 720, the technique 700 determines whether to make parameter changes based on the driver's responses. These responses are converted to text using natural language processing (NLP) techniques, facilitating real-time adaptation of the deceleration algorithm. For example, if the driver agrees to adjust the deceleration parameter, future stops will reflect this change, ensuring a personalized driving experience.

As described above with respect to the SCM, the vehicle, if configured with SCM, would not stop on its own. Thus, while not specifically shown in FIG. 7, the technique 700 includes a mechanism to prompt the driver to press the brake pedal when approaching the stop line. This prompt is issued if the vehicle is within a certain threshold distance to the stop line, the modified APO value falls below a specified level (e.g., less than 0.1), and there have been no driver-initiated overrides of the accelerator or brake during the execution of the auto-deceleration algorithm. Additionally, to allow the driver adequate time to respond, the technique 700 issues the brake prompt approximately 1 second before the vehicle would need to come to a complete stop. This timing may be adjusted based on driver preferences; for instance, the driver may choose to brake earlier or later depending on their stopping habits or situational needs, such as positioning for a right turn on red.

FIG. 8A is a flowchart of a technique 800 for calculating a distance of a vehicle to a stop line. At 802, a current position of the vehicle is obtained as latitude and longitude coordinates using GPS data. The latitude and longitude coordinates can be obtained from the GPS unit 524 of FIG. 5. At 804, this position data is then converted to map coordinates (x, y) to match the vehicle's location on a pre-loaded map, often referred to as a “bootstrap map.”

Once the map coordinates are established, the technique 800 moves to 806, where the nearest map-matched lane is calculated. This step involves identifying the lane in which the vehicle is traveling, enabling accurate positioning within the map framework.

At 808, the technique 800 calculates a distance “S,” which represents the distance traveled by the vehicle in its current lane. This value, “S,” helps in determining how much distance remains within the lane segment. At 810, using the information about the remaining distance in the current lane and the lane segments ahead up to the stop line, the technique 800 calculates the total distance to the stop line. This involves summing up the distances of each successive lane segment from the vehicle's current position to the stop line.

FIG. 8B is used to illustrate the steps 808 and 810 in the flowchart of FIG. 8A. FIG. 8B illustrates a scene 850 in which a vehicle 852 is traveling along a trajectory 854, which may consist of multiple roads and/or lanes, towards a stop line 856. The trajectory 854 is partitioned into multiple lane segments, each with an assigned lane identifier (ID) and length in the bootstrap map. For instance, the trajectory includes lane segments 858A through 858N, with respective IDs 1 through N and lengths D₁ through D_{N}.

Since the vehicle 852 is on the lane segment 858B, the technique 800 leverages the lengths (D₂, . . . , D_{N}) of each lane segment along with the distance “S” (e.g., a distance 860) within the initial lane segment to calculate the total distance to the stop line 856. The distance to the stop line is determined by subtracting “S” from the length of the current lane (D₂−S) (e.g., a remaining distance 862) and adding the lengths of all subsequent lane segments up to the stop line. As such, the distance to the stop line can be calculated as: (D₂−S)+D₃+ . . . +D_{N}.

Since the exact intent of the driver may not be known (e.g., whether the driver intends to go straight, turn right, or turn left), the dynamic regenerative braking module 510 may perform a lookahead analysis to calculate the distance to the stop line across multiple lanes and possible routes that the driver may choose, such as making a left or right turn or continuing straight. This lookahead analysis can be defined by reading the vehicle's turn signals, which helps determine the driver's intended path. Based on this data, the system differentiates between two types of stop lines: (1) regular stop lines, such as those at intersections without traffic lights, and (2) traffic light-controlled stop lines, where the movement of the vehicle is dependent on the traffic light status.

If the stop line is associated with a traffic light, the status of the light is checked in relation to the driver's intended route. For example, if the traffic light is red and the driver intends to go straight or turn in the indicated direction, the remaining distance to the stop line is calculated and the deceleration plan is prepared for execution. Alternatively, if the traffic light is green, the driver is prompted to resume control via a manual takeover by providing prompts through the HMI.

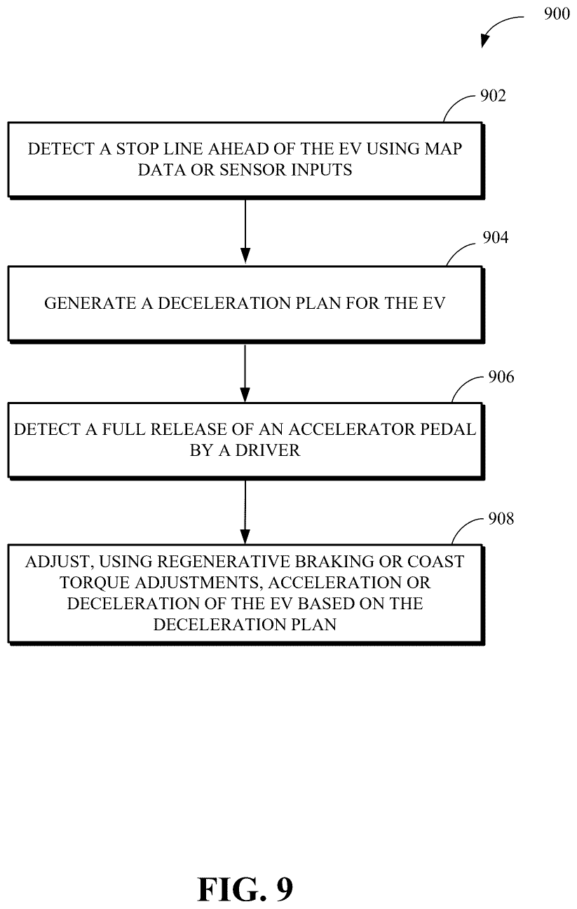

FIG. 9 is a flowchart of a technique 900 for implementing one-pedal driving in an EV by dynamically managing deceleration to achieve smooth stops at stop lines. This technique may be executed via a combination of hardware and software components within the EV. The technique 900 may be executed by a processor, such as the processor 133 of FIG. 1. The technique 900 may be stored in a non-transitory computer readable medium, such as the memory 134, as instructions executable by the processor. The technique 900 can be performed, for example, by executing respective machine-readable programs or other computer-executable instructions. The steps, or operations, of each of the technique 900 or another technique, method, process, or algorithm described in connection with the implementations disclosed herein can be implemented directly in hardware, firmware, software executed by hardware, circuitry, or a combination thereof.

At 902, a stop line ahead of the EV is detected using map data or sensor inputs. Map data may provide positional information about stop lines within the EV's path, while sensor inputs, such as camera or radar, provide real-time data regarding upcoming stops. At 904, a deceleration plan is generated for the EV. This plan is derived based on the distance to the detected stop line and the current speed of the EV. The deceleration plan defines how the vehicle will decelerate as it approaches the stop line, ensuring a controlled and safe stop. In some implementations, the deceleration plan may include a lookup table (LUT) that, given the distance to the stop line, provides a target deceleration value, facilitating precise deceleration adjustments.

Generating the deceleration plan can include generating a speed plan for the electric vehicle, the speed plan comprising a distance from a current location of the electric vehicle to the stop line along a path of the electric vehicle; generating a discrete-time deceleration plan from the speed plan by segmenting the speed plan into time intervals, each time interval having a time step, and for certain ones of the time intervals, determining an acceleration or deceleration value to be used by the electric vehicle to enable the electric vehicle to approach the stop line; and generating a lookup table that maps a distance along the path to an acceleration or deceleration value for the certain ones of the time intervals.

At 906, a full release of the accelerator pedal by the driver is detected. This detection signals the initiation of the deceleration plan, as the EV transitions. At 908, acceleration or deceleration is adjusted based on the deceleration plan using regenerative braking or coast torque adjustments. The deceleration plan guides how much regenerative braking or coast torque should be applied at each stage of the approach to the stop line, promoting energy-efficient braking. In some cases, regenerative braking force is dynamically adjusted based on the degree of pedal release, road conditions, vehicle weight, and remaining distance to the stop line, to optimize the stopping process.

In some implementations, the technique 800 can include outputting, at a predefined distance from the stop line, an instruction directing the driver to apply a brake pedal of the EV, wherein the predefined distance is calculated based on a speed of the EV and regenerative braking capability.

In some implementations, the technique 800 includes detecting a driver override input during acceleration or deceleration, the driver override input comprising either pressing a brake pedal of the EV or pressing the accelerator pedal; and, in response to detecting the driver override input, discontinuing the deceleration plan and applying a corresponding action.

In some implementation, the technique 800 includes soliciting feedback from the driver regarding a performance of the regenerative braking system; adjusting braking parameters based on received feedback from the driver, including modifying a braking sensitivity or a level of regenerative braking applied; and storing driver preferences for future use in similar driving conditions. The feedback may be solicited using a voice-based HMI system. The feedback may be solicited using a graphical interface on a display within the EV.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or” unless specified otherwise, or clear from context. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A method implemented by an electric vehicle (EV) using one-pedal driving, comprising:
detecting a stop line ahead of the EV using map data or sensor inputs;
generating a deceleration plan for the EV, wherein the deceleration plan is based on at least a distance to the stop line, a current speed of the EV, and wherein the deceleration plan ends at the stop line;
detecting a full release of an accelerator pedal by a driver; and
adjusting, using regenerative braking or coast torque adjustments, acceleration or deceleration of the EV based on the deceleration plan.

2. The method of claim 1, further comprising:
outputting, at a predefined distance from the stop line, an instruction directing the driver to apply a brake pedal of the EV, wherein the predefined distance is calculated based on a speed of the EV and regenerative braking capability.

3. The method of claim 1, further comprising:
detecting a driver override input during acceleration or deceleration, the driver override input comprising either pressing a brake pedal of the EV or pressing the accelerator pedal; and
in response to detecting the driver override input, discontinuing the deceleration plan and applying a corresponding action.

4. The method of claim 1, wherein the deceleration plan comprises a lookup table (LUT) that, given a current distance to the stop line, provides a corresponding target deceleration value.

5. The method of claim 1, wherein generating the deceleration plan comprises:
generating a speed plan for the electric vehicle, the speed plan comprising a distance from a current location of the electric vehicle to the stop line along a path of the electric vehicle;
generating a discrete-time deceleration plan from the speed plan by segmenting the speed plan into time intervals, each time interval having a time step, and for certain ones of the time intervals, determining an acceleration or deceleration value to be used by the electric vehicle to enable the electric vehicle to approach the stop line; and
generating a lookup table that maps a distance along the path to an acceleration or deceleration value for the certain ones of the time intervals.

6. The method of claim 1, further comprising:
soliciting feedback from the driver regarding a performance of the regenerative braking system;
adjusting braking parameters based on received feedback from the driver, including modifying a braking sensitivity or a level of regenerative braking applied; and
storing driver preferences for future use in similar driving conditions.

7. The method of claim 6, wherein the feedback is solicited using a voice-based HMI system.

8. The method of claim 6, wherein the feedback is solicited using a graphical interface on a display within the EV.

9. An electric vehicle (EV), comprising:
a processor, configured to:
detect a stop line ahead of the EV using map data or sensor inputs;
generate a deceleration plan for the EV, wherein the deceleration plan is based on at least a distance to the stop line, a current speed of the EV, and wherein the deceleration plan ends at the stop line;
detect a full release of an accelerator pedal by a driver; and
adjust, using regenerative braking or coast torque adjustments, acceleration or deceleration of the EV based on the deceleration plan.

10. The electric vehicle of claim 9, wherein the processor is further configured to:
output, at a predefined distance from the stop line, an instruction directing the driver to apply a brake pedal of the EV, wherein the predefined distance is calculated based on a speed of the EV and regenerative braking capability.

11. The electric vehicle of claim 9, wherein the processor is further configured to:
detect a driver override input during acceleration or deceleration, the driver override input comprising either pressing a brake pedal of the EV or pressing the accelerator pedal; and
in response to detecting the driver override input, discontinue the deceleration plan and applying a corresponding action.

12. The electric vehicle of claim 9, wherein the deceleration plan comprises a lookup table (LUT) that, given a current distance to the stop line, provides a corresponding target deceleration value.

13. The electric vehicle of claim 9, wherein to generate the deceleration plan comprises to:
generate a speed plan for the electric vehicle, the speed plan comprising a distance from a current location of the electric vehicle to the stop line along a path of the electric vehicle;
generate a discrete-time deceleration plan from the speed plan by segmenting the speed plan into time intervals, each time interval having a time step, and for certain ones of the time intervals, determining an acceleration or deceleration value to be used by the electric vehicle to enable the electric vehicle to approach the stop line; and
generate a lookup table that maps a distance along the path to an acceleration or deceleration value for the certain ones of the time intervals.

14. The electric vehicle of claim 9, wherein the processor is further configured to:
solicit feedback from the driver regarding a performance of the regenerative braking system;
adjust braking parameters based on received feedback from the driver, including modifying a braking sensitivity or a level of regenerative braking applied; and
storing driver preferences for future use in similar driving conditions.

15. The electric vehicle of claim 14, wherein the feedback is solicited using a voice-based HMI system.

16. A non-transitory computer readable medium storing instructions operable to cause a processor to perform operations with respect to an electric vehicle (EV) using one-pedal driving, the operations comprising:
detecting a stop line ahead of the EV using map data or sensor inputs;
generating a deceleration plan for the EV, wherein the deceleration plan is based on at least a distance to the stop line, a current speed of the EV, and wherein the deceleration plan ends at the stop line;
detecting a full release of an accelerator pedal by a driver; and
adjusting, using regenerative braking or coast torque adjustments, acceleration or deceleration of the EV based on the deceleration plan.

17. The non-transitory computer readable medium of claim 16, wherein the operations further comprise:
outputting, at a predefined distance from the stop line, an instruction directing the driver to apply a brake pedal of the EV, wherein the predefined distance is calculated based on a speed of the EV and regenerative braking capability.

18. The non-transitory computer readable medium of claim 16, wherein the operations further comprise:
detecting a driver override input during acceleration or deceleration, the driver override input comprising either pressing a brake pedal of the EV or pressing the accelerator pedal; and
in response to detecting the driver override input, discontinuing the deceleration plan and applying a corresponding action.

19. The non-transitory computer readable medium of claim 16, wherein the deceleration plan comprises a lookup table (LUT) that, given a current distance to the stop line, provides a corresponding target deceleration value.

20. The non-transitory computer readable medium of claim 16, wherein generating the deceleration plan comprises:
generating a speed plan for the electric vehicle, the speed plan comprising a distance from a current location of the electric vehicle to the stop line along a path of the electric vehicle;
generating a discrete-time deceleration plan from the speed plan by segmenting the speed plan into time intervals, each time interval having a time step, and for certain ones of the time intervals, determining an acceleration or deceleration value to be used by the electric vehicle to enable the electric vehicle to approach the stop line; and
generating a lookup table that maps a distance along the path to an acceleration or deceleration value for the certain ones of the time intervals.
